(19) United States
(12) Patent Application Publication
(10) Pub. No.: US 2006/0125932 A1
(43) Pub. Date: Jun. 15, 2006

(54) Integrated circuit chip with an image sensor and a backend processing module built therein

(75) Inventors: Chih-Hung Lu, Hsinchu Hsien (TW); Chin-Hsin Yang, Hsinchu Hsien (TW)

Correspondence Address: PILLSBURY WINTHROP SHAW PITTMAN, LLP, P.O. BOX 10500, MCLEAN, VA, 22102, US

(73) Assignee: PIXART IMAGING INC., Hsinchu-Hsien (TW)

(21) Appl. No.: 11/200,048

(22) Filed: Aug. 10, 2005

(30) Foreign Application Priority Data
Dec. 13, 2004 (TW) 093138556

(51) Int. Cl. H04N 5/228

(52) U.S. Cl. 348/222.1

(57) ABSTRACT

An integrated circuit chip includes an image sensor and a backend processing module. The image sensor is adapted for generating an image output corresponding to a captured image. The backend processing module is coupled to the image sensor, and includes an image processing unit for digital processing of the image output from the image sensor to result in a digital image output, and a peripheral control unit coupled to the image processing unit for converting the digital image output into a data transmission standard format for subsequent output.

### CROSS-REFERENCE TO RELATED APPLICATION

This application claims priority of Taiwanese application no. 093138556, filed on Dec. 13, 2004.

### BACKGROUND OF THE INVENTION

1. Field of the Invention

The invention relates to an integrated circuit chip, more particularly to an integrated circuit chip that is suitable for use in digital cameras and that has an image sensor and a backend processing module built therein.

2. Description of the Related Art

Referring to FIG. 1, a conventional digital camera 5 is shown to include an imaging unit 51 having an image sensor 510 and at least an optical component 511, a backend integrated circuit (backend IC) 52, a peripheral control unit 53, a transmission interface 54, and a dynamic random access memory (DRAM) 55. It should be noted herein that the image sensor 510, the backend IC 52, the peripheral control unit 53, the transmission interface 54 and the DRAM 55 are implemented using separate integrated circuit chips that are mounted on a circuit board.

Aside from the aforesaid components, the digital camera 5 can include other accessories, such as a flash-light 61 for providing auxiliary lighting, a liquid crystal display (LCD) 62 for image display, a flash card 63 for storage of image data, etc. These accessories enhance convenience when taking pictures.

In use, light 501 reflected from a target object (not shown) passes through the optical component 511 to form a captured image that is converted into an analog signal 502 by the image sensor 510. The backend IC 52 is responsible for processing of signals from the imaging unit 51, the peripheral control unit 53 and the DRAM 55. In particular, the backend IC 52 is responsible for digitizing of the analog signal 502, image compression, peripheral input/output control, etc.

The transmission interface 54 is coupled to the backend IC 52, and converts signals processed by the latter into a format suitable for transmission to an electronic apparatus, such as a computer 6, for subsequent processing. The peripheral control unit 53 is responsible for controlling operations of the flash-light 61, the LCD 62, the flash card 63, etc.

Since the image sensor 510, the backend IC 52, the peripheral control unit 53, the transmission interface 54 and the DRAM 55 are implemented using separate integrated circuit chips that are mounted on a circuit board, several drawbacks are encountered, such as large power consumption, large space requirement, higher fabrication costs, etc.

### SUMMARY OF THE INVENTION

Therefore, the object of the present invention is to provide an integrated circuit chip that has an image sensor and a backend processing module built therein so as to overcome the aforesaid drawbacks of the prior art.

Accordingly, an integrated circuit chip of this invention comprises an image sensor and a backend processing module. The image sensor is adapted for generating an image output corresponding to a captured image. The backend processing module is coupled to the image sensor, and includes an image processing unit for digital processing of the image output from the image sensor to result in a digital image output, and a peripheral control unit coupled to the image processing unit for converting the digital image output into a data transmission standard format for subsequent output.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram to illustrate internal components of a conventional digital camera;

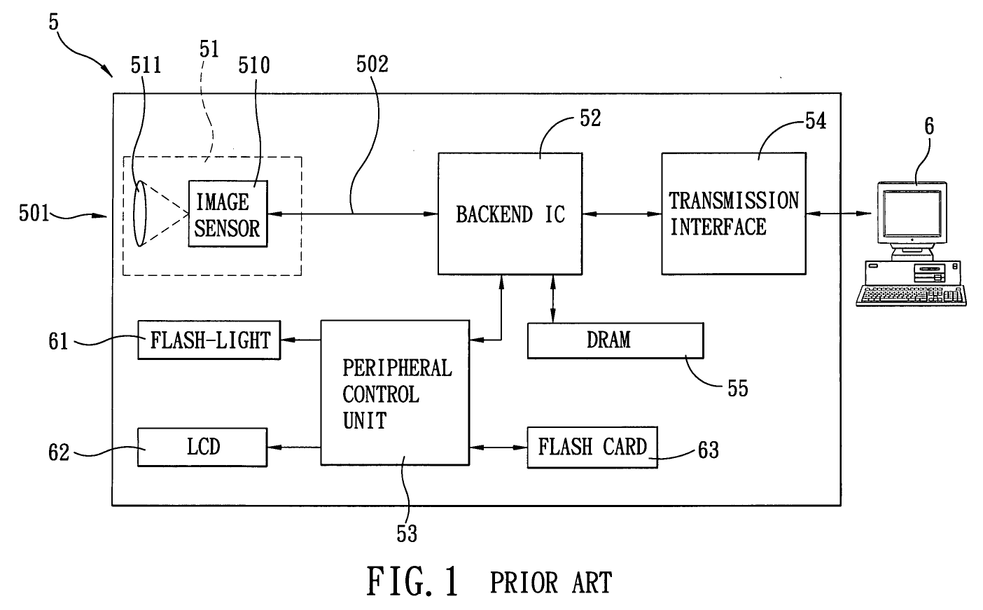

FIG. 2 is a schematic diagram to illustrate a digital camera that incorporates the preferred embodiment of an integrated circuit chip according to the present invention; and

FIG. 3 is a block diagram of the preferred embodiment.

### DETAILED DESCRIPTION OF THE PREFERRED EMBODIMENT

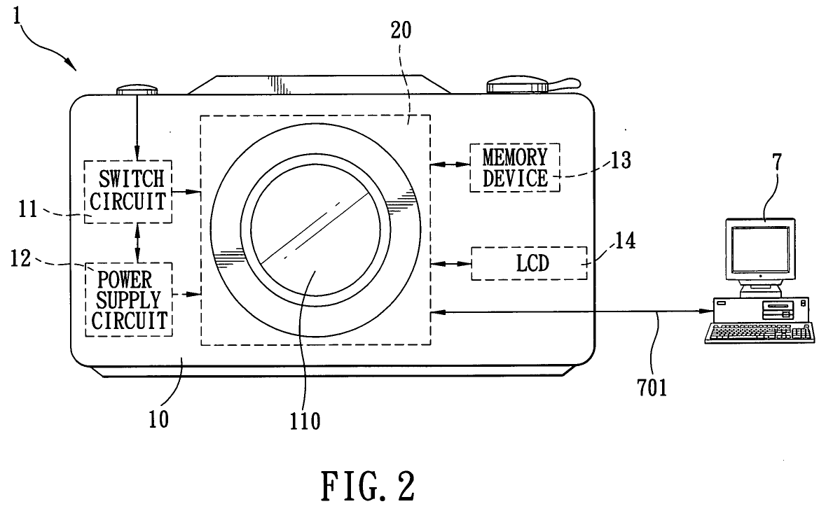

Referring to FIG. 2, the preferred embodiment of an integrated circuit chip 20 according to the present invention is shown to be disposed in a housing 10 of an image capturing device 1. The housing 10 is provided with an optical component 110 for guiding light reflected from a target object (not shown) to the integrated circuit chip 20. The integrated circuit chip 20 is responsible for image capturing and data storage and retrieval operations. It is noted that the integrated circuit chip 20 is suitable for taking still and moving pictures, and is thus applicable to various image capturing devices 1, such as digital still cameras, digital video cameras, camera phones, etc.

The image capturing device 1 further includes a switch circuit 11, a power supply circuit 12, a memory device 13 and a liquid crystal display (LCD) 14 coupled to the integrated circuit chip 20. The image capturing device 1 is adapted for connection to an external image processing system 7 through a cable 701 to permit transfer of image data to and from the image processing system 7 for subsequent processing. The switch circuit 11 is used to control picture taking activity and activation/deactivation of the power supply circuit 12. The power supply circuit 12 provides electric power to the image capturing device 1. Since the construction and operation of the switch circuit 11 and the power supply circuit 12 are known to those skilled in the art and are not pertinent to the claimed invention, they will not be described further for the sake of brevity.

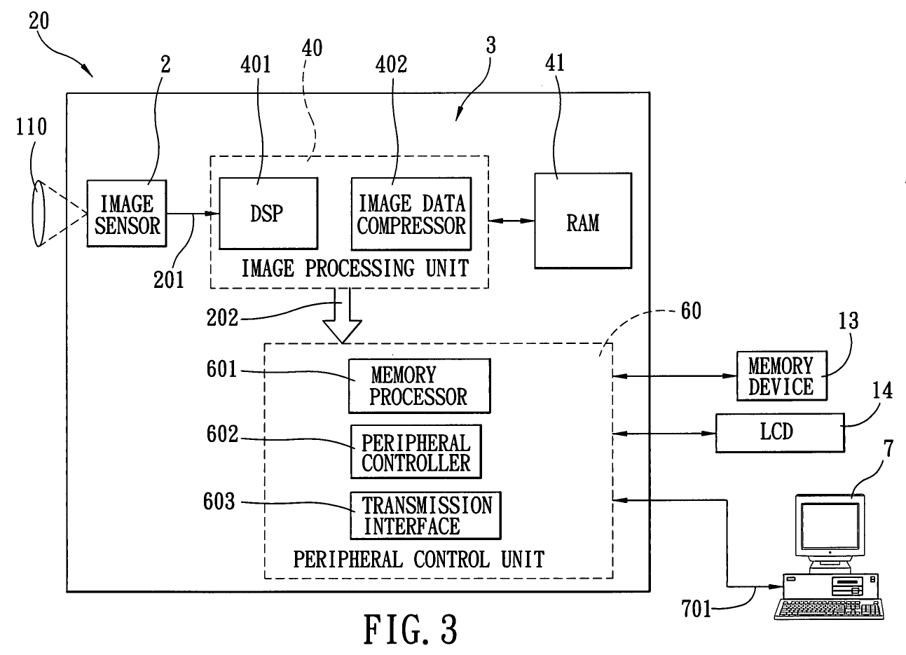

As shown in FIG. 3, the integrated circuit chip 20 includes an image sensor 2 and a backend processing module 3 coupled to the image sensor 2. The backend processing module 3 includes an image processing unit 40 and a peripheral control unit 60. The image processing unit 40 is coupled to a random access memory (RAM) 41.

The image sensor 2 includes a sensor array, a read out circuit, a timing controller, etc., and is adapted for generating an image output 201 corresponding to a captured image in a conventional manner. The image processing unit 40 is responsible for digital processing of the image output 201 from the image sensor 2 to result in a digital image output 202. The RAM 41 serves as a data buffer for the image processing unit 40. The peripheral control unit 60 is coupled to the image processing unit 40, and is responsible for converting the digital image output 202 into a data transmission standard format, such as the universal serial bus (USB) format, for subsequent output to the external image processing system 7.

The image processing unit 40 includes a digital signal processor (DSP) 401 for converting the image output 201 from the image sensor 2 into a digital format, and an image data compressor 402 for performing data compression according to known data compression algorithms, such as JPEG image compression, differential pulse code modulation, etc., thereby saving space for image data files.

The peripheral control unit 60 includes a memory processor 601 coupled to the image processing unit 40 and adapted for coupling to the memory device 13 for data storage and retrieval. In this embodiment, the memory device 13 is a static random access memory, which has a lower I/O pin count (i.e., 16 pins) as compared to conventional dynamic random access memory (i.e., 40 pins). As a result, the number of designated pins of the integrated circuit chip 20 for coupling to the memory device 13 is lowered so as to reduce the size of the integrated circuit chip 20.

The peripheral control unit 60 further includes a peripheral controller 602 adapted for coupling to the LCD 14 and for controlling display of images on the LCD 14. The peripheral controller 602 is also adapted for controlling other input/output devices (not shown), such as a flash card, a flash-light, etc., in a conventional manner.

The peripheral control unit 60 further includes a transmission interface 603 for converting the digital image output 202 into the universal serial bus (USB) format for subsequent output to the image processing system 7.

In the integrated circuit chip 20 of this invention, the image sensor 2 and the backend processing module 3 are integrated into a single chip to result in lower power consumption, smaller space requirement and lower fabrication costs as compared to the prior art. Furthermore, since the integrated circuit chip 20 is suitable for use with a static random access memory 13, the I/O pin count thereof is decreased as compared to that required when using a dynamic random access memory so as to further reduce the size of the integrated circuit chip 20, which meets current trends toward miniaturization.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. An integrated circuit chip comprising:
an image sensor adapted for generating an image output corresponding to a captured image; and
a backend processing module coupled to said image sensor and including
an image processing unit for digital processing of the image output from said image sensor to result in a digital image output, and
a peripheral control unit coupled to said image processing unit for converting the digital image output into a data transmission standard format for subsequent output.

2. The integrated circuit chip as claimed in claim 1, wherein said image processing unit includes a digital signal processor for converting the image output from said image sensor into a digital format.

3. The integrated circuit chip as claimed in claim 2, wherein said image processing unit further includes an image data compressor for data compression.

4. The integrated circuit chip as claimed in claim 1, wherein said peripheral control unit includes a memory processor coupled to said image processing unit and adapted for coupling to an external memory device for data storage and retrieval.

5. The integrated circuit chip as claimed in claim 1, wherein said peripheral control unit includes a peripheral controller adapted for coupling to a liquid crystal display device.

6. The integrated circuit chip as claimed in claim 1, wherein said peripheral control unit includes a transmission interface for converting the digital image output into a universal series bus format.
